(19) United States
(12) Patent Application Publication
(10) Pub. No.: US 2016/0240915 A1
(43) Pub. Date: Aug. 18, 2016

(54) IN-MOLD ANTENNA, APPARATUS FOR CONTROLLING ANTENNA CHARACTERISTICS AND METHOD FOR MANUFACTURING IN-MOLD ANTENNA

(71) Applicant: SAMSUNG ELECTRO-MECHANICS CO., LTD., Suwon-si (KR)

(72) Inventors: Hyeon Gil NAM, Suwon-si (KR); Dae Seong JEON, Suwon-si (KR); Hyun Sam MUN, Suwon-si (KR)

(73) Assignee: SAMSUNG ELECTRO-MECHANICS CO., LTD., Suwon-si (KR)

(21) Appl. No.: 14/969,799

(22) Filed: Dec. 15, 2015

(30) Foreign Application Priority Data
Feb. 12, 2015 (KR) 10-2015-0021735

(51) Int. Cl. H01Q 1/40

(52) U.S. Cl. CPC H01Q 1/40

(57) ABSTRACT

An in-mold antenna include a first antenna pattern having a first surface and a second surface, interposed between the first and second surface, a second antenna pattern that is attached to the first surface of the first antenna pattern and through which current passes from the first antenna pattern, and a cut section provided by cutting the first antenna pattern at the second surface. By controlling the shape of the cut section, it is possible to affect resonance characteristics of the antenna, and a corresponding apparatus and method do so.

### CROSS-REFERENCE TO RELATED APPLICATION(S)

This application claims the benefit under 35 USC 119(a) of Korean Patent Application No. 10-2015-0021735 filed on Feb. 12, 2015 in the Korean Intellectual Property Office, the entire disclosure of which is incorporated herein by reference for all purposes.

### BACKGROUND

1. Field

The following description relates to an in-mold antenna, an apparatus for controlling antenna characteristics, and a method for manufacturing such an in-mold antenna.

2. Description of Related Art

In general, an in-mold antenna (IMA) is embedded in a case of a communications apparatus such as a mobile communications terminal, or a similar electronic device that includes a communications module using an in-mold technique. The IMA may be connected to the communications module to be used for transmission and reception of electromagnetic waves. For example, such an IMA may be integrated with the communication device's case to maximize the antenna pattern volume, which helps improve the performance of the antenna.

During a process of manufacturing such an in-mold antenna, defects may occur in the in-mold antenna due to dimensional deviations in molds used for manufacturing the in-mold antenna and work deviations during the process of manufacturing the in-mold antenna. However, the defects of the in-mold antenna may be checked for by performing an antenna characteristics inspection.

According to the alternative approaches, the antenna characteristics inspection of the in-mold antenna is performed after the in-mold antenna is manufactured. Therefore, in such a case in which the manufactured in-mold antennas are determined to be defective, the corresponding in-mold antennas are unusable and are discarded. Furthermore, because characteristics of in-molded antennas may vary widely, due to slight variations in a large number of molds used in the process of mass-manufacturing in-molded antennas, the frequency of the occurrence of defects increase when using alternative approaches.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the present examples provide an in-mold antenna, an apparatus for controlling antenna characteristics, and a method for manufacturing such an in-mold antenna.

In one general aspect, an in-mold antenna includes a first antenna pattern having a first surface and a second surface, wherein the first antenna pattern is interposed between the first surface and the second surface, a second antenna pattern that is attached to the first surface of the first antenna pattern and through which current passes from the first antenna pattern, and a cut section formed by cutting the first antenna pattern at the second surface.

An area of the cut section may be increased in proportion to an impedance of the first antenna pattern.

The cut section may be formed by laser cutting, and the cut section may be formed by cutting from the second surface across towards the first surface.

A width of the cut section may be less than a width of the first antenna pattern.

A width of the cut section may be greater than or equal to a width of the first antenna pattern.

The cut section may extend to be formed into a portion of the second antenna pattern.

An aspect of the shape of the cut section may be chosen to affect a resonance frequency of the first antenna pattern.

The aspect of the shape of the cut section may be an area of the cut section, a position of the cut section, a direction of the cut section, or a thickness of the cut section.

The in-mold antenna may further include at least one additional cut section formed by cutting the first antenna pattern at the second surface.

In another general aspect, an apparatus for controlling antenna characteristics includes a characteristics inspector configured to inspect characteristics of a first antenna pattern provided with a second antenna pattern that is attached to a first surface of the first antenna pattern, a cutter configured to cut the second surface of the first antenna pattern to form a cut section, and a cut controller configured to determine characteristics of a cut section that is cut by the cutter on the basis of characteristics inspected by the characteristics inspector.

The characteristics inspector may apply current to the first antenna pattern to inspect a resonance frequency or an impedance of the first antenna pattern.

In response to a resonance frequency of the first antenna pattern inspected by the characteristics inspector being higher than a first frequency, the cutter may cut a portion of the second antenna pattern together with the first antenna pattern.

In response to a resonance frequency of the first antenna pattern inspected by the characteristics inspector being equal to or lower than a second frequency, the cutter may stop cutting the first antenna pattern.

The cut controller may compare an impedance of the first antenna pattern inspected by the characteristics inspector with a reference impedance to determine an area of the cut section cut by the cutter on the basis of impedance comparison results.

An aspect of the shape of the cut section may be chosen to affect a resonance frequency of the first antenna pattern.

The aspect of the shape of the cut section may be an area of the cut section, a position of the cut section, a direction of the cut section, or a thickness of the cut section.

The cutter may be further configured to cut the second surface of the first antenna pattern to form at least one additional cut section.

In another general aspect, a method for controlling antenna characteristics includes forming a first antenna pattern with a second antenna pattern that is attached to a first surface of the first antenna pattern, inspecting characteristics of the first antenna pattern, and cutting at least a portion of a second surface of the first antenna pattern to form a cut section.

Characteristics of the cut section may be determined on the basis of the inspected characteristics.

Other features and aspects will be apparent from the following detailed description, the drawings, and the claims.

### BRIEF DESCRIPTION OF THE DRAWINGS

FIG. 1 is a view illustrating an in-mold antenna according to an example.

FIG. 2 is a view illustrating a current flow of the in-mold antenna illustrated in the example of FIG. 1.

FIG. 3 is a view illustrating a current flow of an in-mold antenna having a relatively long cut section.

FIG. 4 is a view illustrating a current flow of an in-mold antenna having a relatively short cut section.

FIG. 5 is a view illustrating an apparatus for controlling antenna characteristics according to an example.

FIG. 6 is a view illustrating changes in resonance frequency according to characteristics of the cut section illustrated in the figure of FIG. 5.

FIG. 7 is a graph illustrating changes in resonance frequency according to a position of the cut section and an area of the cut section illustrated in the example of FIG. 5.

FIG. 8 is a flowchart illustrating a method for manufacturing an in-mold antenna according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Examples are now described in further detail with reference to the accompanying drawings.

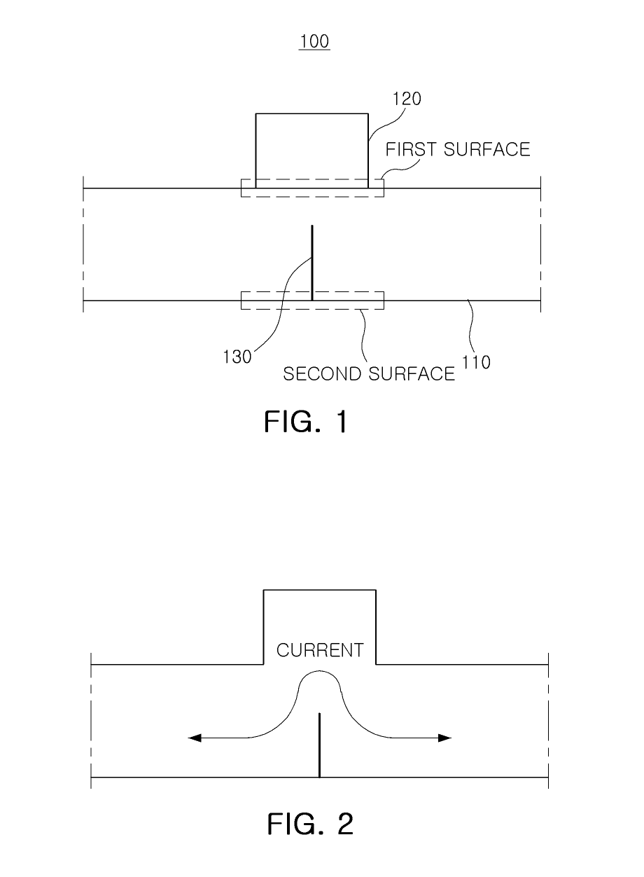

FIG. 1 is a view illustrating an in-mold antenna according to an example.

Referring to the example of FIG. 1, an in-mold antenna 100 includes a first antenna pattern 110, a second antenna pattern 120, and a cut section 130.

For example, the first antenna pattern 110 transmits and receives electromagnetic waves as a result of the flow of current. For example, the first antenna pattern 110 is potentially connected to a main circuit board, not illustrated, on which a communications module is mounted. As another example, the first antenna pattern 110 is operated by receiving power from a feeding connector, not illustrated.

The second antenna pattern 120 is attached to a first surface of the first antenna pattern 110. Thus, current flows through the second antenna pattern 120 and the first antenna pattern 110. For example, the current flow in an order of the first antenna pattern 110, the second antenna pattern 120, and then the first antenna pattern 110. By varying a path of the current, impedance of the first antenna pattern to which the second antenna pattern 120 is attached is varied accordingly.

For example, the first surface is implemented in various ways in various examples, depending on a shape of the first antenna pattern 110. For example, the first surface is located in a region in which the first antenna pattern 110 is not densely formed. Thus, an effect of the second antenna pattern 120 on other regions of the first antenna pattern 110 is reduced, and the occurrence of attachment defects and positioning defects of the cut section 130 are prevented.

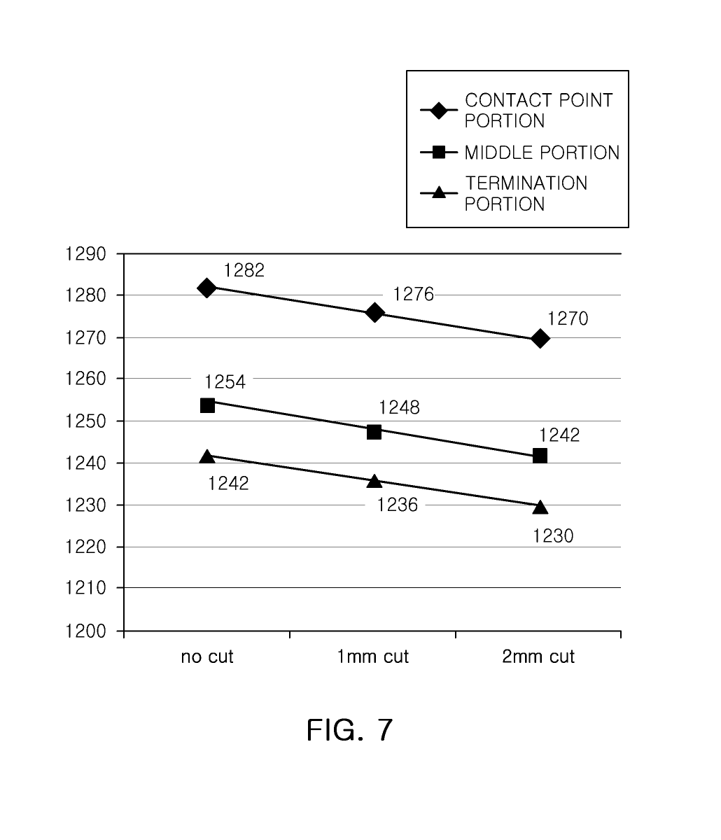

Meanwhile, in an example in which the first surface is implemented in various ways, impedance of the first antenna pattern 110 is also implemented in various ways. For example, impedance of the first antenna pattern 110 in an example in which the second antenna pattern 120 is attached to a middle portion of the first antenna pattern 110 and impedance of the first antenna pattern 110 in an example in which the second antenna pattern 120 is attached to a termination portion of the first antenna pattern 110 potentially differ from each other. Results of comparing these alternative examples are illustrated further, subsequently, in a graph of FIG. 7.

The cut section 130 is provided by cutting a second surface of the first antenna pattern 110. By forming such a cut section 130, the current flowing in the first antenna pattern 110 does not penetrate through the cut section 130 and instead flows through the second antenna pattern 120 by bypassing the cut section 130.

Here, the cut section 130 refers to a space that is dug in a groove shape in the first antenna pattern 110. For example, the cut section 130 is also being formed at the time of initially machining the first antenna pattern 110. Hence, in such an example, these two portions of the antenna are formed at the same time. Thus, the cut section 130 is not to be interpreted as only a space which is cut after the initial machining, but instead is formed at different times in different example.

In one example, the cut section 130 is formed by laser cutting. Therefore, characteristics of the cut section 130 are precisely adjusted by changing how the laser cutting occurs. In this example, characteristics of the cut section 130 potentially include aspects such as an area of the cut section, a position of the cut section, a direction of the cut section, a thickness of the cut section, the number of cut sections, and other similar factors that govern the form of the cut section and how it affects the electrical properties of the antenna.

For example, the impedance of the first antenna pattern 110 increases in proportion to the area of the cut section 130. That is, as the area of the cut section 130 is increased, a path of the current flowing in the first antenna pattern 110 also increases. Because in an example in which the path of the current is increased, correspondingly resistance, inductance, or other similar attributes of the first antenna pattern 110 are increased, the impedance of the first antenna pattern 110 is increased.

Here, the cut section 130 is also provided in the second surface of the first antenna pattern 110 and a portion of the second antenna pattern 120. For example, in an example in which the impedance of the first antenna pattern 110 is to be increased, the area of the cut section 130 is also increased, and thereby achieves the desired effect. Hence, because the area of the cut section 130 is possibly larger than an area of the cross section of the first antenna pattern 110, the cut section 130 is also optionally extended to be formed so as to be in the portion of the second antenna pattern 120 as well.

The impedance of the first antenna pattern 110 is precisely adjusted by precise formation of the cut section 130, as discussed. Thus, antenna characteristics, such as a resonance frequency, and other electromagnetic characteristics that control the functioning of the in-mold antenna 100 are precisely adjusted.

Thus, the in-mold antenna 100 reduces the frequency of the occurrence of defects.

FIG. 2 is a view illustrating a current flow of the in-mold antenna illustrated in the example of FIG. 1.

Referring to FIG. 2, the current flowing in the first antenna pattern does not penetrate through the cut section and instead flows in the first antenna pattern by bypassing the cut section.

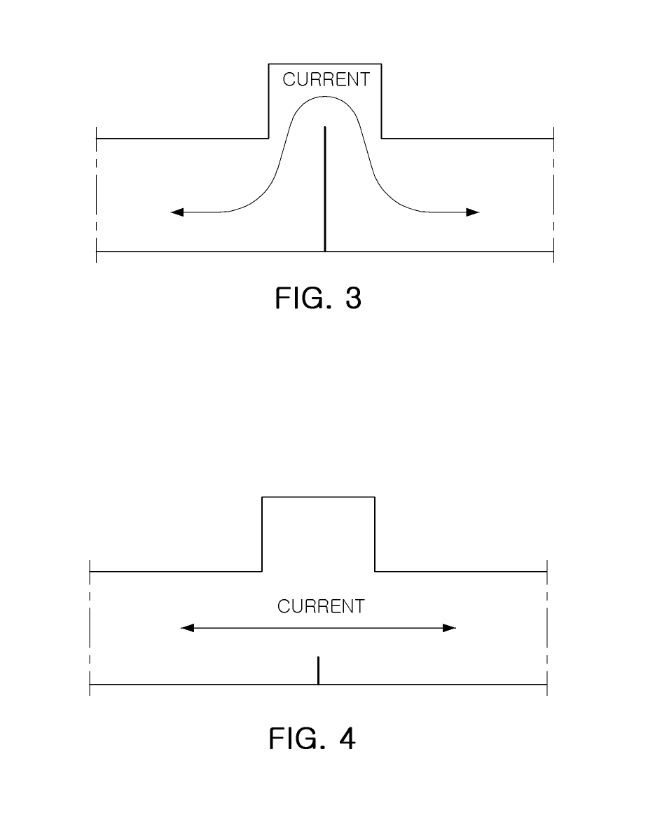

FIG. 3 is a view illustrating a current flow of an in-mold antenna having a relatively long cut section.

Referring to the example of FIG. 3, the cut section is also formed, in such an example, so that it extends across both the first antenna pattern and the second antenna pattern. Thus, the path of the current flowing in the first antenna pattern 110 is further increased in such an example.

FIG. 4 is a view illustrating a current flow of an in-mold antenna having a relatively short cut section.

Referring to FIG. 4, the area of the cut section is decreased, so that it does not extend as far. As a result, the path of the current flowing in the first antenna pattern 110 is decreased. In a case in which the cut section is very short, the current flowing in the first antenna pattern 110 flows in a path that is similar to the path of the current flowing in the first antenna pattern 110 in an example in which the cut section is not formed.

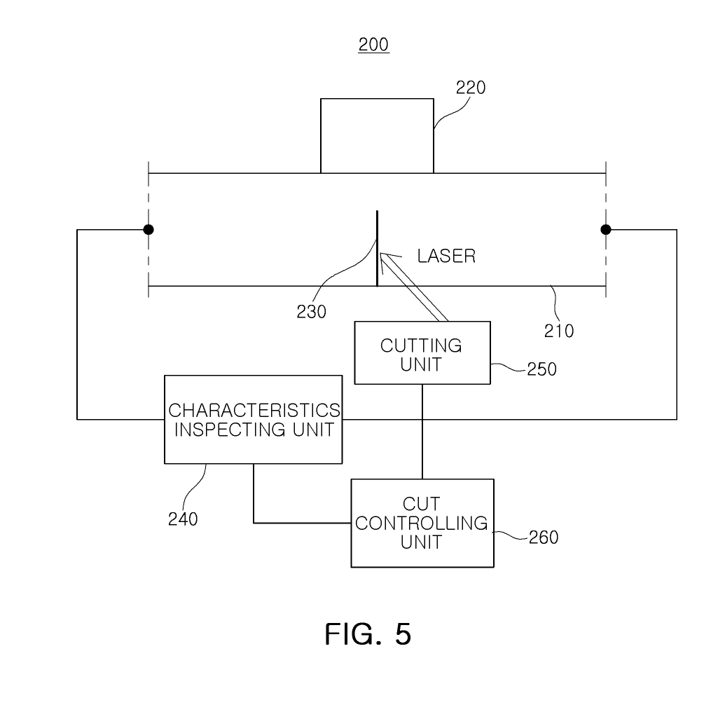

FIG. 5 is a view illustrating an apparatus for controlling antenna characteristics according to an example.

Referring to the example of FIG. 5, an apparatus 200 for controlling antenna characteristics includes a characteristics inspecting unit 240, a cutting unit 250, and a cut controlling unit 260.

In such an example, the characteristics inspecting unit 240 inspects characteristics of a first antenna pattern 210 provided with a second antenna pattern 220 that is attached to a first surface of the first antenna pattern 210.

For example, the characteristics inspecting unit 240 applies current to the first antenna pattern 210 to inspect a resonance frequency or impedance of the first antenna pattern 210.

Also, the cutting unit 250 cut a second surface of the first antenna pattern 210 to create the cut section, as discussed above. For example, the cutting unit 250 allows a laser to be applied to the second surface of the first antenna pattern 210 to form a cut section 230 by using a precisely controlled laser as a cutting tool.

For example, when a resonance frequency of the first antenna pattern inspected by the characteristics inspecting unit 240 is higher than a first frequency, the cutting unit 250 cut a portion of the second antenna pattern 220 along with the first antenna pattern 210. That is, as illustrated in the example of FIG. 3, the cut section 230 is formed to be larger and have a greater effect on the current path.

Alternatively, when the resonance frequency of the first antenna pattern inspected by the characteristics inspecting unit 240 is lower than a second frequency, the cutting unit 250 does not cut the first antenna pattern 210. Here, the example in which the first antenna pattern 210 is not cut potentially has the same or a similar outcome as an example in which the cut 230 is very short. That is, the example in which the cut 230 is formed as illustrated in FIG. 4 is substantially the same as the case in which the cutting unit 250 does not cut the first antenna pattern 210, in that there is no significant effect on currently flow in this example.

Thus, under certain conditions, the cutting unit 250 adjusts the resonance frequency or impedance of the first antenna pattern 210 by tuning the first antenna pattern 210. Thus, antenna characteristics of the first antenna pattern 210 are controlled, and costs incurred in discarding defective in-mold antennas are correspondingly reduced because the examples provide a way of controlling for defects that manages the potential presence of defects.

The cut controlling unit 260 determines characteristics of the cut section that is cut by the cutting unit 250 on the basis of characteristics of the first antenna pattern inspected by the characteristics inspecting unit 240. As discussed, characteristics of the cut section 230 potentially include factors such as an area of the cut section, a position of the cut section, a direction of the cut section, a thickness of the cut section, the number of cut sections, and other aspects of the formation of the cut section.

For example, the cut controlling unit 260 compares an impedance of the first antenna pattern inspected by the characteristics inspecting unit 240 with a reference impedance to determine the area of the cut section cut by the cutting unit 250 on the basis of impedance comparison results.

In this example, the reference impedance is estimated impedance of the first antenna pattern 210 that is estimated before inspecting characteristics of the first antenna pattern 210. For example, in an example in which the impedance of the first antenna pattern 210 is found to be lower than the estimated impedance of the first antenna pattern 210, the cut controlling unit 260 controls the cutting unit 250 so that the cut section 230 is relatively long as a compensating factor.

Thus, antenna characteristics are precisely controlled, and costs incurred in discarding the defective in-mold antennas are reduced because it is possible to take corrective action to remedy in-mold antennas that would otherwise be defective.

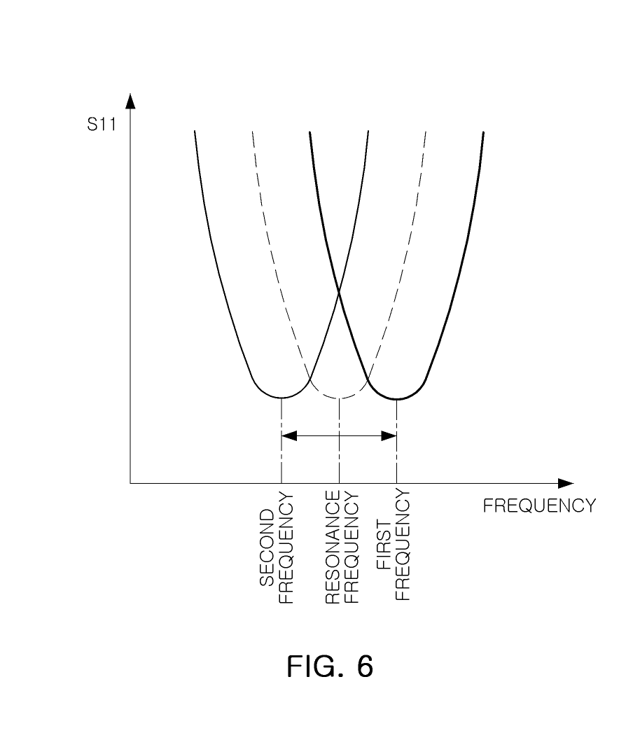

FIG. 6 is a view illustrating changes in resonance frequency according to characteristics of the cut section 230 illustrated in the example of FIG. 5.

Referring to FIG. 6, its horizontal axis denotes a frequency of a current flowing in the antenna pattern, and its vertical axis denotes an S11 value of an S-parameter. In the example of FIG. 6, because the S11 value is low, energy reflected at a frequency corresponding to the S11 value is accordingly low. Thus, a frequency of the lowest S11 value corresponds to the resonance frequency.

Here, as illustrated in the example of FIG. 6, the resonance frequency of the antenna pattern is lower than the first frequency and higher than the second frequency. In such a case, as illustrated in FIG. 2, the cut section 230 is neither long nor short, but is instead of medium length.

In this example, the resonance frequency of the antenna pattern is also higher than the first frequency and lower than that of the second frequency. For example, the resonance frequency of the antenna pattern is classified into three cases. According to the cases of the resonance frequency of the antenna pattern, the cut section formed in the antenna pattern is also classified into three cases as illustrated in FIGS. 2 through 4. As discussed, these cases correspond to sizes of the cut section that are moderate as in FIG. 2, long as in FIG. 3, or short as in FIG. 4.

Thus, the cut controlling unit 260 easily determines characteristics of the cut section to control the cutting unit 250 to cut the in-mold antennas in an effective and advantageous manner.

FIG. 7 is a graph illustrating changes in resonance frequency according to a position of the cut section and an area of the cut section as illustrated in FIG. 5.

Referring to FIG. 7, its horizontal axis denotes an area of the cut section, and its vertical axis denotes the resonance frequency according to the area of the cut section or the point of the cut section.

In the example of FIG. 7, it is observable that as the area of the cut section of the antenna pattern increases, the resonance frequency becomes lower.

In addition, it is observable that the resonance frequency varies in an example in accord with how the position of the cut section of the antenna pattern is varied.

Hereinafter, a method for manufacturing an in-mold antenna according to an example is described further. Descriptions of features that are the same as those of the in-mold antenna 100 or the apparatus 200 for controlling antenna characteristics described above with reference to FIGS. 1 and 5 are omitted for brevity.

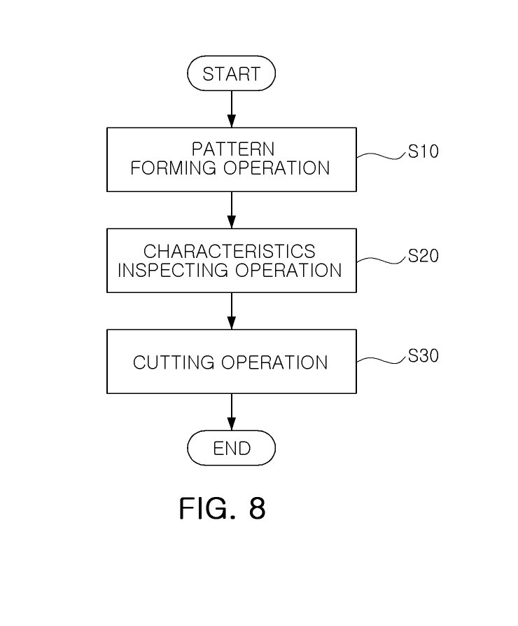

FIG. 8 is a flowchart illustrating a method for manufacturing an in-mold antenna according to an example.

Referring to the example of FIG. 8, the method for manufacturing an in-mold antenna includes a pattern forming operation, a characteristics inspecting operation, and a cutting operation.

In the pattern forming operation S10, a first antenna pattern is formed so as to be provided with a second antenna pattern that is attached to a first surface of the first antenna pattern.

In the characteristics inspecting operation S20, characteristics of the first antenna pattern formed in the pattern forming operation S10 may be inspected. By inspecting these characteristics, it becomes possible to determine how to cut to overcome any defects that may be present in the in-mold antenna that was originated in the pattern forming operation S10.

In the cutting operation S30, at least a portion of a second surface of the first antenna pattern may be cut to form a cut section. Here, appropriate corresponding characteristics of the cut section in the cutting operation S30 are be determined on the basis of the inspected characteristics, derived previously.

For example, when a resonance frequency or impedance of the first antenna pattern inspected in the characteristics inspecting operation S20 is out of a preset range, an area of the cut section may be changed. For example, the area is changed in a way that compensates for the manner in which the antenna pattern deviates from the preset range.

As set forth above, according to the examples, the in-mold antenna may reduce the frequency of the occurrence of defects. As noted, this is possible because potential defects are identified and corrected.

Hence, the apparatus for controlling antenna characteristics according to the examples reduces the occurrence of defects by controlling antenna characteristics.

The method for manufacturing an in-mold antenna according to the examples reduces defects occurring during a process of manufacturing the in-mold antenna by taking appropriate corrective actions.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation,

Expressions such as “first conductivity type” and “second conductivity type” as used herein may refer to opposite conductivity types such as N and P conductivity types, and examples described herein using such expressions encompass complementary examples as well. For example, an example in which a first conductivity type is N and a second conductivity type is P encompasses an example in which the first conductivity type is P and the second conductivity type is N.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An in-mold antenna comprising:
a first antenna pattern having a first surface and a second surface, wherein the first antenna pattern is interposed between the first surface and the second surface;
a second antenna pattern that is attached to the first surface of the first antenna pattern and through which current passes from the first antenna pattern; and
a cut section formed by cutting the first antenna pattern at the second surface.

2. The in-mold antenna of claim 1, wherein an area of the cut section is increased in proportion to an impedance of the first antenna pattern.

3. The in-mold antenna of claim 1, wherein the cut section is formed by laser cutting, and
the cut section is formed by cutting from the second surface across towards the first surface.

4. The in-mold antenna of claim 1, wherein a width of the cut section is less than a width of the first antenna pattern.

5. The in-mold antenna of claim 1, wherein a width of the cut section is greater than or equal to a width of the first antenna pattern.

6. The in-mold antenna of claim 1, wherein the cut section extends to be formed into a portion of the second antenna pattern.

7. The in-mold antenna of claim 1, wherein an aspect of the shape of the cut section is chosen to affect a resonance frequency of the first antenna pattern.

8. The in-mold antenna of claim 7, wherein the aspect of the shape of the cut section is an area of the cut section, a position of the cut section, a direction of the cut section, or a thickness of the cut section.

9. The in-mold antenna of claim 1, further comprising at least one additional cut section formed by cutting the first antenna pattern at the second surface.

10. An apparatus for controlling antenna characteristics, the apparatus comprising:
a characteristics inspector configured to inspect characteristics of a first antenna pattern provided with a second antenna pattern that is attached to a first surface of the first antenna pattern;
a cutter configured to cut the second surface of the first antenna pattern to form a cut section; and
a cut controller configured to determine characteristics of a cut section that is cut by the cutter on the basis of characteristics inspected by the characteristics inspector.

11. The apparatus of claim 10, wherein the characteristics inspector applies current to the first antenna pattern to inspect a resonance frequency or an impedance of the first antenna pattern.

12. The apparatus of claim 10, wherein in response to a resonance frequency of the first antenna pattern inspected by the characteristics inspector being higher than a first frequency, the cutter cuts a portion of the second antenna pattern together with the first antenna pattern.

13. The apparatus of claim 10, wherein in response to a resonance frequency of the first antenna pattern inspected by the characteristics inspector being equal to or lower than a second frequency, the cutter stops cutting the first antenna pattern.

14. The apparatus of claim 10, wherein the cut controller compares an impedance of the first antenna pattern inspected by the characteristics inspector with a reference impedance to determine an area of the cut section cut by the cutter on the basis of impedance comparison results.

15. The apparatus of claim 10, wherein an aspect of the shape of the cut section is chosen to affect a resonance frequency of the first antenna pattern.

16. The apparatus of claim 15, wherein the aspect of the shape of the cut section is an area of the cut section, a position of the cut section, a direction of the cut section, or a thickness of the cut section.

17. The apparatus of claim 10, wherein the cutter is further configured to cut the second surface of the first antenna pattern to form at least one additional cut section.

18. A method for controlling antenna characteristics comprising:
forming a first antenna pattern with a second antenna pattern that is attached to a first surface of the first antenna pattern;
inspecting characteristics of the first antenna pattern; and
cutting at least a portion of a second surface of the first antenna pattern to form a cut section.
